(19) United States
(12) Patent Application Publication
(10) Pub. No.: US 2026/0280642 A1
(43) Pub. Date: Sep. 17, 2026

(54) CRITERIA TO IDENTIFY CHANNEL MEASUREMENT RESOURCES FOR MULTIPLE TIME DOMAIN OCCASIONS LAYER 1 REPORT

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US)

(21) Appl. No.: 19/469,144

(22) PCT Filed: May 19, 2023
(86) PCT No.: PCT/CN2023/095214

§ 371 Date: Sep. 25, 2025

(51) Int. Cl. H04B 7/06; H04W 24/10; H04W 72/0446

(52) U.S. Cl. CPC H04B 7/0626; H04W 24/10; H04W 72/0446

(57) ABSTRACT

Various aspects of the present disclosure generally relate to wireless communication. In some aspects, a user equipment (UE) may receive a channel state information (CSI) report configuration associated with reporting Layer 1 (L1) measurements across multiple occasions in a time domain. The UE may select, among a set of candidate channel measurement resources (CMRs) that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained. The UE may transmit a CSI report that includes the L1 measurements associated with the one or more CMRs across the multiple occasions in the time domain. Numerous other aspects are described.

### FIELD OF THE DISCLOSURE

Aspects of the present disclosure generally relate to wireless communication and to techniques and apparatuses associated with criteria to identify channel measurement resources for a multiple time domain occasions Layer 1 report.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include receiving a channel state information (CSI) report configuration associated with reporting Layer 1 (L1) measurements across multiple occasions in a time domain. The method may include selecting, among a set of candidate channel measurement resources (CMRs) that are associated with L1 measurements across the multiple occasions in the time domain, one or more CMRs based on one or more candidate selection criteria, wherein the one or more candidate selection criteria are based on at least one of a relative strength of the L1measurements or occasions in which the L1 measurements are obtained. The method may include transmitting a CSI report that includes the L1 measurements associated with the one or more CMRs across the multiple occasions in the time domain.

Some aspects described herein relate to a UE for wireless communication. The UE may include one or more memories and one or more processors coupled to the one or more memories. The one or more processors may be configured to receive a CSI report configuration associated with reporting L1 measurements across multiple occasions in a time domain. The one or more processors may be configured to select, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained. The one or more processors may be configured to transmit a CSI report that includes the L1 measurements associated with the one or more CMRs across the multiple occasions in the time domain.

Some aspects described herein relate to a non-transitory computer-readable medium that stores a set of instructions for wireless communication by a UE. The set of instructions, when executed by one or more processors of the UE, may cause the UE to receive a CSI report configuration associated with reporting L1 measurements across multiple occasions in a time domain. The set of instructions, when executed by one or more processors of the UE, may cause the UE to select, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained. The set of instructions, when executed by one or more processors of the UE, may cause the UE to transmit a CSI report that includes the L1 measurements associated with the one or more CMRs across the multiple occasions in the time domain.

Some aspects described herein relate to an apparatus for wireless communication. The apparatus may include means for receiving a CSI report configuration associated with reporting L1 measurements across multiple occasions in a time domain. The apparatus may include means for selecting, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained. The apparatus may include means for transmitting a CSI report that includes the L1 measurements associated with the one or more CMRs across the multiple occasions in the time domain.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating examples of beam management procedures based on downlink reference signal transmissions, in accordance with the present disclosure.

FIG. 4 is a diagram illustrating an example of artificial intelligence or machine learning based beam management and a Layer 1 (L1) report that captures multiple historical time domain measurement occasions for one or more channel measurement resources (CMRs), in accordance with the present disclosure.

FIGS. 5A-5B are diagrams illustrating examples associated with criteria to identify CMRs for a multiple time domain occasions L1 report, in accordance with the present disclosure.

FIG. 6 is a diagram illustrating an example process associated with criteria to identify CMRs for a multiple time domain occasions L1 report, in accordance with the present disclosure.

FIG. 7 is a diagram of an example apparatus for wireless communication, in accordance with the present disclosure.

### DETAILED DESCRIPTION

In a wireless network, a user equipment (UE) and a network node may communicate to perform beam management. For example, in some cases, beam management may include beam selection procedures, initial beam acquisition procedures, beam sweeping procedures, cell search procedures, and/or beam search procedures in which the network node performs beam sweeping over multiple transmit (Tx) beams (e.g., transmitting a synchronization signal block (SSB) or channel state information (CSI) reference signal (CSI-RS) using multiple transmit beams). Additionally, or alternatively, the beam management procedures may include beam refinement procedures, network node beam refinement procedures, transmission reception point (TRP) beam refinement procedures, and/or transmit beam refinement procedures in which the network node performs beam sweeping over one or more transmit beams, and the UE measures each beam using a single (e.g., a same) receive beam. Additionally, or alternatively, the beam management procedures may include beam refinement procedures, beam failure detection procedures, beam failure recovery procedures, UE beam refinement procedures, and/or receive beam refinement procedures in which the network node transmits one or more downlink signals using a single transmit beam, and the UE sweeps through one or more receive beams in multiple transmission instances to select a best receive beam based at least in part on measurements reported by the UE.

In some cases, advances in technology have enabled development of beam management techniques based on artificial intelligence (AI) and/or machine learning (ML) techniques. For example, a network node may transmit one or more signals to a UE using a first set of beams, and the UE may perform measurements for the first set of beams to obtain a first set of measurements. For example, each beam, from the first set of beams, may be associated with one or more measurements performed by the UE, which may be input into an artificial intelligence or machine learning (AI/ML) model along with information associated with the first set of beams, such as a beam direction (e.g., spatial direction), beam width, beam shape, and/or other characteristics of the respective beams from the first set of beams. Additionally, or alternatively, an output of the AI/ML model may include a point-direction, an angle of departure (AoD), and/or an angle of arrival (AoA) of a beam included in a second set of beams. The AI/ML model may then output one or more predictions, such as predicted measurement values associated with the second set of beams, which may reduce a quantity of beam measurements that are performed by the UE, thereby conserving power of the UE and/or network resources that would have otherwise been used to measure all beams included in the first set of beams and the second set of beams.

In general, historical beam measurements in one CSI reporting instance may be used to assist with AI and/or ML techniques providing high performance beam management. For example, in some AI/ML beam management techniques, a multiplexed CSI report can include historical beam measurements, where a CSI report transmitted in one uplink transmission occasion can include multiple CSI reports that each corresponds to different non-zero power (NZP) CSI-RS occasions by configuring multiple CSI reports with overlapping uplink transmission occasions. However, existing beam reporting mechanisms are not optimized for historical beam measurement reports. For example, techniques to report Layer 1 (L1) reference signal received power (RSRP) (L1-RSRP) measurements typically convey an RSRP of a CSI-RS resource indicator (CRI) and/or SSB resource indicator (SSBRI) associated with a strongest (e.g., largest) RSRP. As a result, each CSI report might include CRI/SSBRI values for different beams over time. However, to track beam quality, data showing how the quality of a beam changes in a time domain may be useful to a UE. In that sense, a common CRI/SSBRI of beam reporting over time domain may improve time domain beam prediction. In addition, an uplink control information (UCI) payload size may be reduced if a common CRI/SSBRI for multiple CSIs is supported. Accordingly, improved L1 beam reporting mechanisms may improve the performance of temporal beam prediction.

Some aspects described herein relate to techniques to identify one or more channel measurement resources (CMRs) to track across multiple measurement occasions in a time domain, such that the one or more CMRs that are tracked across the multiple measurement occasions may be addressed in one or more CSI reports that include L1 measurements for the one or more CMRs. For example, in some aspects, the one or more CSI reports may include an enhanced CSI report that includes a common CRI and/or SSBRI associated with the one or more CMRs and separate L1-RSRP and/or L1 signal-to-interference-plus-noise ratio (SINR) (L1-SINR) measurements associated with each respective CMR. Additionally, or alternatively, multiple CSI reports may be provided by the UE, where the multiple CSI reports each include an L1 measurement associated with one of the CMRs that are tracked over the multiple measurement occasions. Furthermore, some aspects described herein relate to criteria that may be used to identify the CMRs that are tracked over the multiple measurement occasions. For example, in some aspects, the CMRs may correspond to one or more candidate CMRs that have strongest L1 measurements in a first occasion, of the multiple measurement occasions in the time domain, one or more candidate CMRs that have strongest L1 measurements in a last occasion, of the multiple measurement occasions in the time domain, one or more candidate CMRs that have strongest L1 measurements, averaged over the multiple measurement occasions in the time domain, and/or one or more candidate CMRs that were reported and/or had strong L1 measurements in one or more previous measurement occasions and/or CSI reporting instances. Additionally, or alternatively, the UE may autonomously select one or more criteria that are used to identify the CMRs to be addressed in one or more CSI reports that span multiple measurement occasions. Furthermore, some aspects described herein relate to techniques that a network node may use to configure or indicate the criteria to be used to select the CMRs to be addressed in the one or more CSI reports and/or techniques that a UE may use to indicate the criteria that were used to select the CMRs addressed in the one or more CSI reports. In this way, some aspects described herein may be used to identify the CMRs that a UE tracks over time, which may improve L1 beam reporting mechanisms that track multiple historical time domain occasions associated with identical CMRs and thereby improve the performance of temporal beam prediction.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

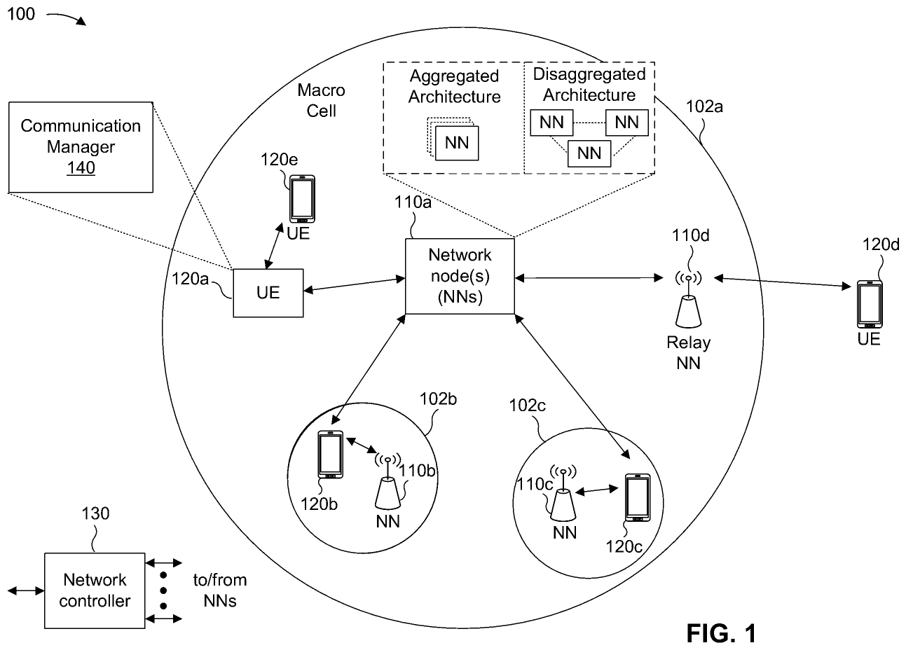

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a TRP, a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IOT) devices, and/or may be implemented as NB-IOT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHZ) and FR2 (24.25 GHz-52.6 GHZ). It should be understood that although a portion of FR 1 is greater than 6 GHz, FR 1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2characteristics, and thus may effectively extend features of FR1 and/or FR2 into mid-band frequencies. In addition, higher frequency bands are being explored to extend 5G NR operation beyond 52.6 GHz. For example, three higher operating bands have been identified as frequency range designations FR4a or FR4-1 (52.6 GHz-71 GHz), FR4(52.6 GHZ-114.25 GHZ), and FR5 (114.25 GHZ-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR 1, or may include mid-band frequencies. Further, unless specifically stated otherwise, it should be understood that the term “millimeter wave” or the like, if used herein, may broadly represent frequencies that may include mid-band frequencies, may be within FR2, FR4,FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive a CSI report configuration associated with reporting L1 measurements across multiple occasions in a time domain; select, among a set of candidate CMRs that are associated with L1 measurements across the multiple occasions in the time domain, one or more CMRs based on one or more candidate selection criteria, wherein the one or more candidate selection criteria are based on at least one of a relative strength of the L1measurements or occasions in which the L1 measurements are obtained; and transmit a CSI report that includes the L1 measurements associated with the one or more CMRs across the multiple occasions in the time domain. Additionally, or alternatively, the communication manager 140 may perform one or more other operations described herein.

As indicated above, FIG. 1 is provided as an example. Other examples may differ from what is described with regard to FIG. 1.

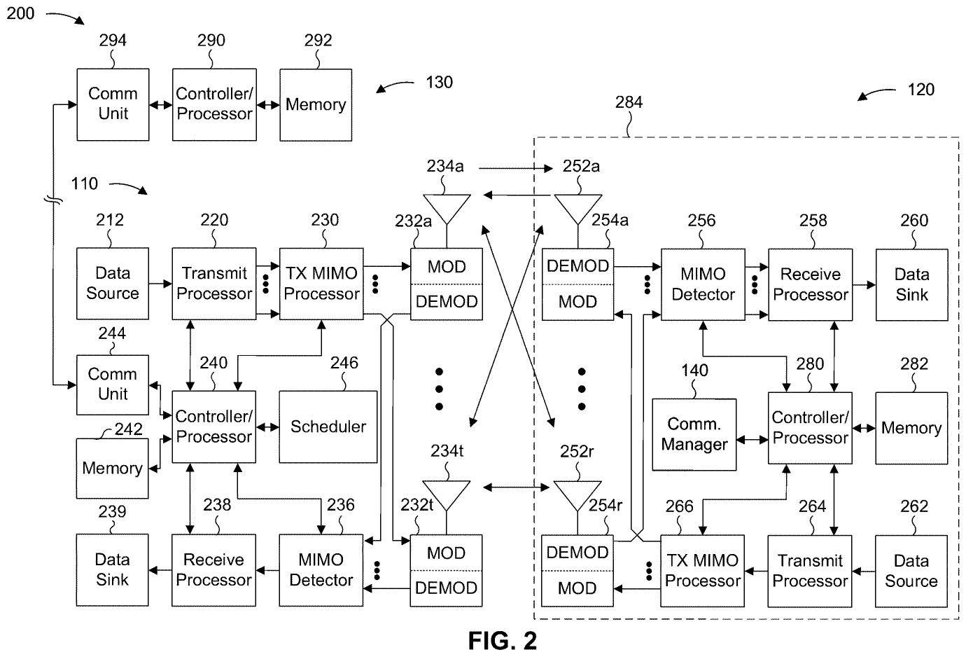

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R ≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., Toutput symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254 a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine an RSRP parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

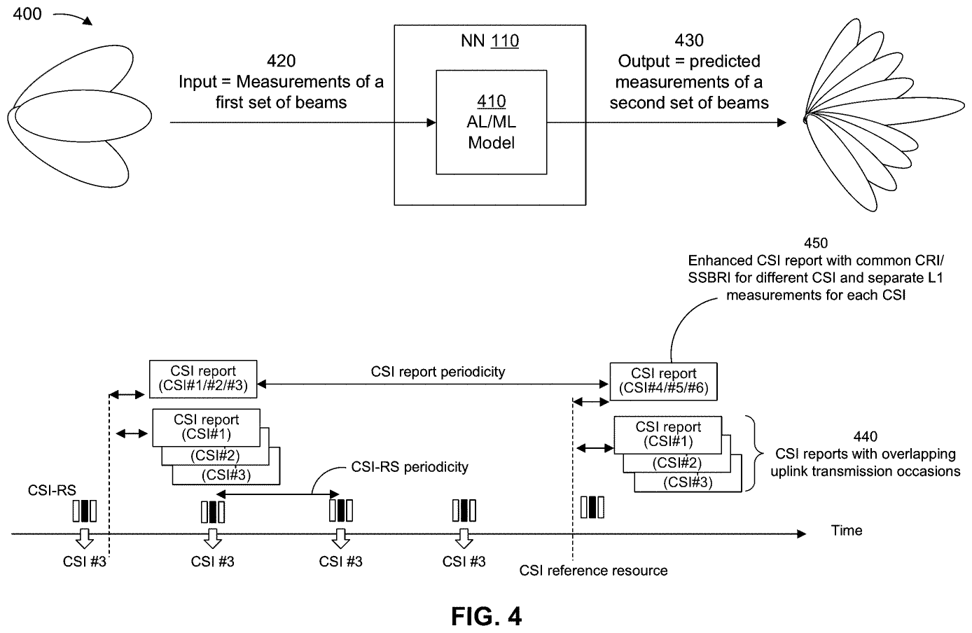

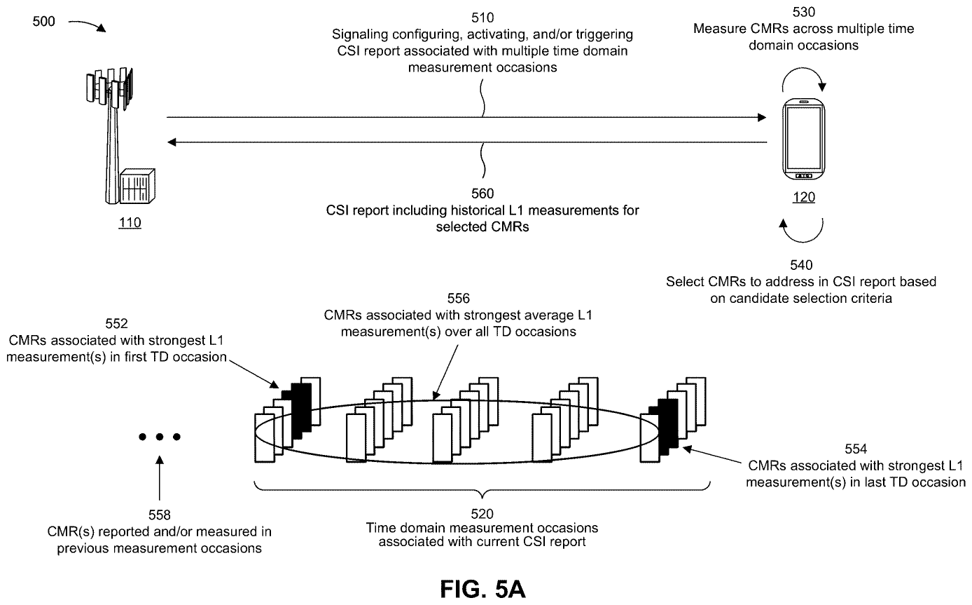

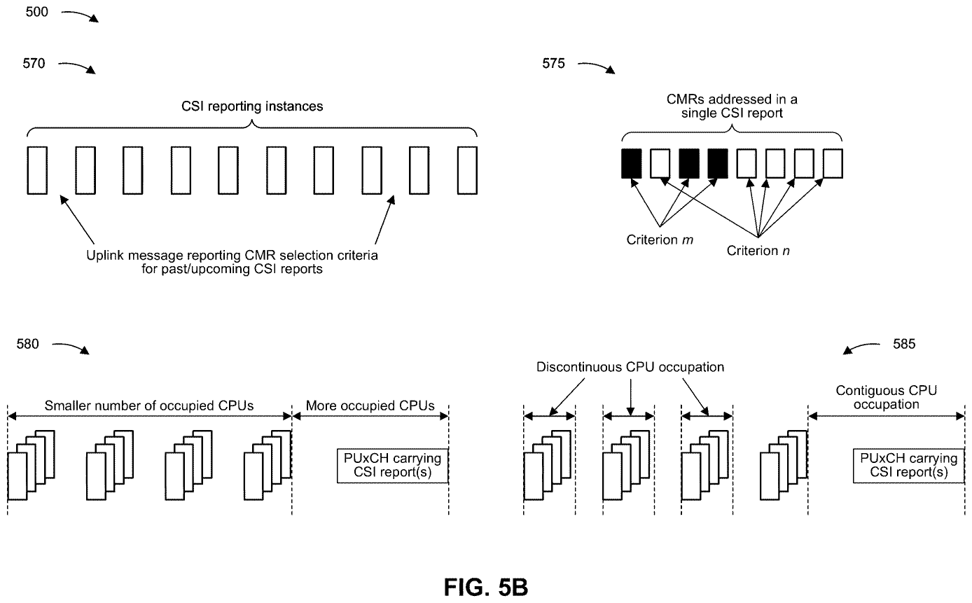

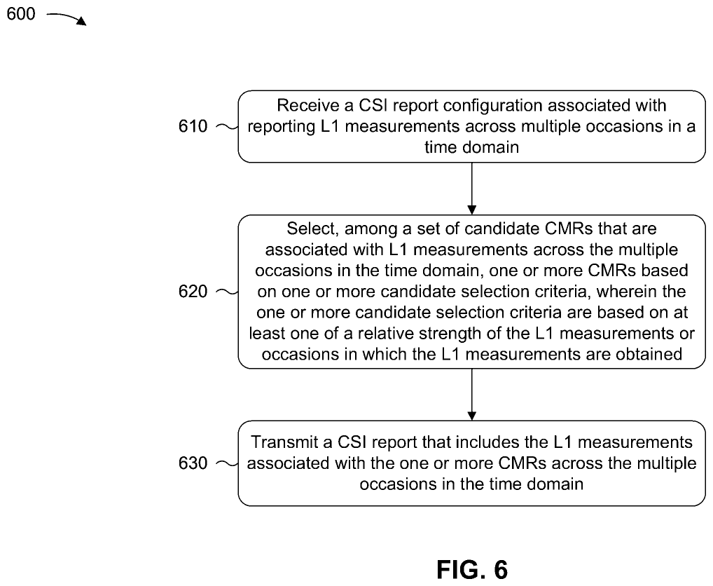

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-4B, FIG. 5, and/or FIG. 6).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-4B, FIG. 5, and/or FIG. 6).

The controller/processor 240 of the network node 110, the controller/processor 280 of the UE 120, and/or any other component(s) of FIG. 2 may perform one or more techniques associated with criteria to identify CMRs for a multiple time domain occasions L1 report, as described in more detail elsewhere herein. For example, the controller/processor 240 of the network node 110, the controller/processor 280 of the UE 120, and/or any other component(s) of FIG. 2 may perform or direct operations of, for example, process 600 of FIG. 6 and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 600 of FIG. 6 and/or other processes as described herein. In some examples, executing instructions may include running the instructions, converting the instructions, compiling the instructions, and/or interpreting the instructions, among other examples.

In some aspects, the UE 120 includes means for receiving a CSI report configuration associated with reporting L1 measurements across multiple occasions in a time domain; means for selecting, among a set of candidate CMRs that are associated with L1 measurements across the multiple occasions in the time domain, one or more CMRs based on one or more candidate selection criteria, wherein the one or more candidate selection criteria are based on at least one of a relative strength of the L1measurements or occasions in which the L1 measurements are obtained; and/or means for transmitting a CSI report that includes the L1 measurements associated with the one or more CMRs across the multiple occasions in the time domain. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

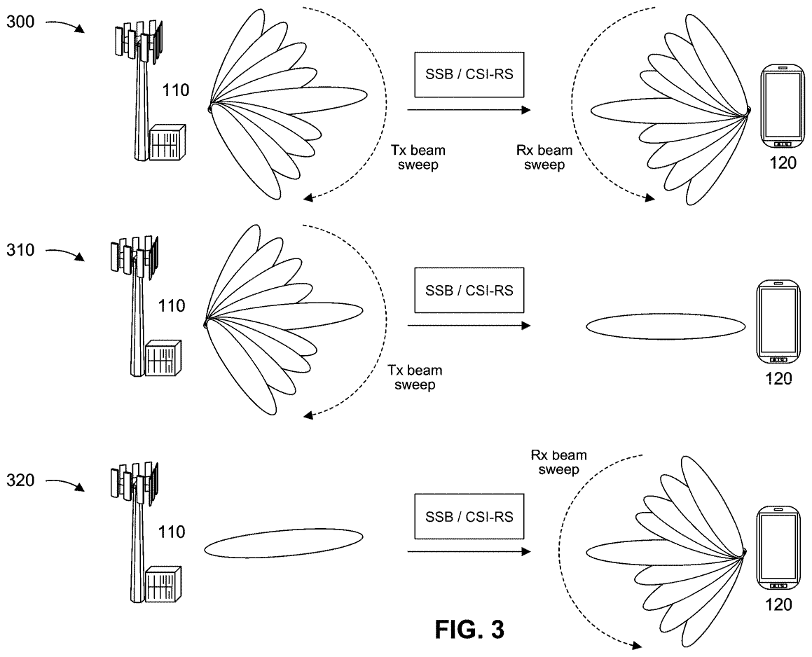

FIG. 3 is a diagram illustrating examples 300, 310, and 320 of beam management procedures based on downlink reference signal transmissions, in accordance with the present disclosure. As shown in FIG. 3, examples 300, 310, and 320 include a UE 120 in communication with a network node 110 in a wireless network (e.g., wireless network 100). However, the devices shown in FIG. 3 are provided as examples, and the wireless network may support communication and beam management between other devices (e.g., between a UE 120 and a TRP, a DU, or an RU, between a mobile termination node and a control node, between an IAB child node and an IAB parent node, and/or between a scheduled node and a scheduling node). In some aspects, the UE 120 and the network node 110 may be in a connected state (e.g., a radio resource control (RRC) connected state) when performing the beam management procedure(s).

As shown in FIG. 3, example 300 may include the network node 110 and the UE 120 communicating to perform beam management using SSB transmissions or CSI-RS transmissions. Example 300 depicts a first beam management procedure (e.g., P1 beam management). The first beam management procedure may be referred to as a beam selection procedure, an initial beam acquisition procedure, a beam sweeping procedure, a cell search procedure, and/or a beam search procedure. As shown in FIG. 3 and example 300, SSBs and/or CSI-RSs may be configured to be transmitted from the network node 110 to the UE 120 during the first beam management procedure. For example, an SSB transmitted by the network node 110 is a single rank (rank-1) periodic reference signal that is always transmitted by the network node 110 to enable initial network acquisition and synchronization in addition to beam selection and beam management. For example, an identifier associated with an SSB may have a one-to-one mapping to a transmit beam used by the network node 110, and the one-to-one mapping may be invariant (e.g., static) over time. Additionally, or alternatively, in cases where CSI-RS transmissions are used for the first beam management procedure, the CSI-RSs used for beam selection or beam management may be configured to be periodic (e.g., using RRC signaling), semi-persistent (e.g., using medium access control (MAC) control element (MAC-CE) signaling), and/or aperiodic (e.g., using downlink control information (DCI)).

The first beam management procedure may include the network node 110 performing a beam sweep over multiple Tx beams. The network node 110 may transmit an SSB or a CSI-RS using each transmit beam for beam management. To enable the UE 120 to perform receive (Rx) beam sweeping, the network node 110 may use a transmit beam to transmit (e.g., with repetitions) each SSB or CSI-RS at multiple times within the same reference signal resource set so that the UE 120 can perform a beam sweep over multiple receive beams in multiple transmission instances. For example, if the network node 110 has a set of N transmit beams and the UE 120 has a set of M receive beams, the SSB or CSI-RS may be transmitted on each of the N transmit beams M times such that the UE 120 may receive M instances of the SSB or CSI-RS per transmit beam. In other words, for each transmit beam of the network node 110, the UE 120 may perform a beam sweep through the receive beams of the UE 120. As a result, the first beam management procedure may enable the UE 120 to measure an SSB or CSI-RS on different transmit beams using different receive beams to support selection of one or more transmit/receive beam pair(s) (e.g., a pairing between a transmit beam of the network node 110 and a receive beam of the UE 120). The UE 120 may report the measurements to the network node 110 to enable the network node 110 to select one or more beam pairs for communication between the network node 110 and the UE 120.

As shown in FIG. 3, example 310 may include the network node 110 and the UE 120 communicating to perform beam management using SSB transmissions or CSI-RS transmissions. Example 310 depicts a second beam management procedure (e.g., P2 beam management). The second beam management procedure may be referred to as a beam refinement procedure, a base station beam refinement procedure, a network node beam refinement procedure, and/or a transmit beam refinement procedure, among other examples. As shown in FIG. 3 and example 310, SSBs and/or CSI-RSs may be configured to be transmitted from the network node 110 to the UE 120. The SSBs may be periodic, and the CSI-RSs may be configured to be aperiodic (e.g., using DCI). The second beam management procedure may include the network node 110 performing a beam sweep over one or more transmit beams. The one or more transmit beams may be a subset of all transmit beams associated with the network node 110 (e.g., determined based at least in part on measurements reported by the UE 120 in connection with the first beam management procedure). The network node 110 may transmit an SSB or a CSI-RS using each transmit beam of the one or more transmit beams for beam management. The UE 120 may measure each SSB or CSI-RS using a single (e.g., a same) receive beam (e.g., determined based at least in part on measurements performed in connection with the first beam management procedure). The second beam management procedure may enable the network node 110 to select a best transmit beam based at least in part on measurements of the SSBs and/or CSI-RSs (e.g., measured by the UE 120 using the single receive beam) reported by the UE 120.

As shown in FIG. 3, example 320 depicts a third beam management procedure (e.g., P3 beam management). The third beam management procedure may be referred to as a beam refinement procedure, a UE beam refinement procedure, a receive beam refinement procedure, and/or a UE beam management procedure, among other examples. As shown in FIG. 3 and example 320, one or more SSBs or CSI-RSs may be configured to be transmitted from the network node 110 to the UE 120. The SSBs may be configured to be periodic, and the CSI-RSs may be configured to be aperiodic (e.g., using DCI). The third beam management process may include the network node 110 transmitting the one or more SSBs or CSI-RSs using a single transmit beam (e.g., determined based at least in part on measurements reported by the UE 120 in connection with the first beam management procedure and/or the second beam management procedure). To enable the UE 120 to perform receive beam sweeping, the network node 110 may use a transmit beam to transmit (e.g., with repetitions) an SSB or CSI-RS at multiple times within the same reference signal resource set such that UE 120 can sweep through one or more receive beams in multiple transmission instances. The one or more receive beams may be a subset of all receive beams associated with the UE 120 (e.g., determined based at least in part on measurements performed in connection with the first beam management procedure and/or the second beam management procedure). The third beam management procedure may enable the UE 120 to select a best receive beam based at least in part on measurements of the SSBs or CSI-RSs and/or may enable the network node 110 to select a best receive beam for the UE 120 based at least in part on reported measurements received from the UE 120 (e.g., measurements of the SSB and/or CSI-RS using the one or more receive beams).

In some cases, the UE 120 and the network node 110 may use beamforming to improve performance associated with downlink and/or uplink communication over a millimeter wave (mmW) channel. For example, a mmW channel (e.g., in FR2 and/or FR4) may suffer from high propagation loss because mmW signals have a higher frequency and a shorter wavelength than various other radio waves used for communications (e.g., sub-6 GHz communications in FR1). As a result, mmW signals often have shorter propagation distances, may be subject to atmospheric attenuation, and/or may be more easily blocked and/or subject to penetration loss through objects or other obstructions, among other examples. For example, a mmW signal may be reflected by lamp posts, vehicles, glass/windowpanes, and/or metallic objects, may be diffracted by edges or corners of buildings and/or walls, and/or may be scattered via irregular objects such as walls and/or human bodies (e.g., a hand blocking an antenna module when a device is operated in a gaming mode). Accordingly, beamforming may be used at both the UE 120 and the network node 110 to counter the propagation loss in a mmW channel and thereby improve performance for mmW communication. For example, to achieve a beamforming gain on a downlink, the network node 110 may generate a downlink transmit beam that is steered in a particular direction, and the UE 120 may generate a corresponding downlink receive beam. Similarly, to achieve a beamforming gain on an uplink, the UE 120 may generate an uplink transmit beam that is steered in a particular direction, and the network node 110 may generate a corresponding uplink receive beam. In some cases, the UE 120 may be permitted to select the downlink receive beam to optimize reception of a downlink transmission from the network node 110 and/or may be permitted to select the uplink transmit beam to optimize reception at the network node 110 for an uplink transmission by the UE 120.

However, in some cases (e.g., when the UE 120 is indoors or moving), a radio link between the UE 120 and the network node 110 may be susceptible to blockage and/or degradation, which may lead to a sudden interruption that results in beam failure. For example, radio link failure (RLF) occurs in a multi-beam scenario when radio problems within a cell cannot be solved by recovery procedures, or the UE 120 is unable to find any suitable beam to initiate a random access procedure and successfully recover the failed connection between the UE 120 and the network node 110. On the other hand, beam failure occurs when the UE 120 has lost a link via a current serving beam (e.g., based on a measurement associated with the current serving beam failing to satisfy a threshold) but the UE 120 is able to use another beam to perform a successful random access procedure to reestablish the (temporarily lost) connection with the network node 110. Accordingly, in some aspects, the UE 120 may be configured with one or more resources to enable beam failure detection, whereby the UE 120 may measure or detect sudden and rapid changes in a communication link and simultaneously recover the communication link to continue services. For example, the UE 120 may be configured to initiate a beam failure recovery (BFR) procedure to select or otherwise configure a new serving beam based on processing at a physical (PHY) layer and a MAC layer without requiring any higher-layer (e.g., RRC) signaling.

As indicated above, FIG. 3 is provided as an example. Other examples may differ from what is described with regard to FIG. 3.

FIG. 4 is a diagram illustrating an example 400 of AI/ML based beam management and an L1 report that captures multiple historical time domain measurement occasions for one or more CMRs, in accordance with the present disclosure. As shown in FIG. 4, an AI/ML model 410 may be deployed at or on a network node 110 (labeled “NN 110” in FIG. 4). For example, a model inference host may be deployed at, or on, a network node 110. The AI/ML model 410 may enable the network node 110 to determine one or more inferences or predictions based on data input to the AI/ML model 410. Additionally, or alternatively, the AI/ML model 410 may be deployed at, or on, a UE 120 to enable the UE 120 to determine one or more inferences or predictions based on data input to the AI/ML model 410.

For example, as shown by reference number 420, an input to the AI/ML model 410 may include measurements associated with a first set of beams. For example, a network node 110 may transmit one or more signals using respective beams from the first set of beams, and a UE 120 may obtain measurements (e.g., L1-RSRP measurements, L1-SINR measurements, or other suitable measurements) of the first set of beams to obtain a first set of measurements. For example, each beam, from the first set of beams, may be associated with one or more measurements performed by the UE 120. The first set of measurements (e.g., L1-RSRP and/or L1-SINR measurement values) may be input into the AI/ML model 410 (e.g., by the network node 110 or the UE 120) along with information associated with the first set of beams and/or a second set of beams, such as a beam direction (e.g., spatial direction), beam width, beam shape, and/or other characteristics of the respective beams from the first set of beams and/or the second set of beams.

As shown by reference number 430, the AI/ML model 410 may output one or more predictions. The one or more predictions may include predicted measurement values (e.g., predicted L1-RSRP and/or L1-SINR measurement values) associated with the second set of beams. This may reduce a quantity of beam measurements that are performed by the UE 120, thereby conserving power of the UE 120 and/or network resources that would have otherwise been used to measure all beams included in the first set of beams and the second set of beams. This type of prediction may be referred to as a codebook-based spatial domain selection or prediction.

As another example, an output of the AI/ML model 410 may include a point-direction, an AoD, and/or an AoA of a beam included in the second set of beams. This type of prediction may be referred to as a non-codebook based spatial domain selection or prediction. As another example, multiple measurement reports or values, collected at different points in time, may be input to the AI/ML model 410. This may enable the AI/ML model 410 to output codebook based and/or non-codebook based predictions for a measurement value, an AoD, and/or an AoA, among other examples, of a beam at a future time. The output(s) of the AI/ML model 410, as described herein, may facilitate initial access procedures, secondary cell group (SCG) setup procedures, beam refinement procedures (e.g., a P2 beam management procedure or a P3 beam management procedure), link quality or interference adaptation procedure, beam failure and/or beam blockage predictions, and/or radio link failure predictions, among other examples.

In some examples, the first set of beams may be referred to as Set B beams and the second set of beams may be referred to as Set A beams. In some examples, the first set of beams (e.g., the Set B beams) may be a subset of the second set of beams (e.g., the Set A beams). In some other examples, the first set of beams and the second set of beams may be different beams and/or may be mutually exclusive sets. For example, the first set of beams (e.g., the Set B beams) may include wide beams (e.g., unrefined beams or beams having a beam width that satisfies a first threshold) and the second set of beams (e.g., the Set A beams) may include narrow beams (e.g., refined beams or beams having a beam width that satisfies a second threshold). In one example, the AI/ML model 410 may perform spatial-domain downlink beam predictions for beams included in the Set A beams based on measurement results of beams included in the Set B beams. As another example, the AI/ML model 410 may perform temporal downlink beam prediction for beams included in the Set A beams based on historic measurement results of beams included in the Set B beams.

In general, historical beam measurements in one CSI reporting instance may be used to assist with AI/ML techniques providing high performance beam management. For example, reference number 440 in FIG. 4 depicts multiplexed CSI reports that can include historical beam measurements, where multiple CSI reports may be transmitted in one uplink transmission occasion, with each CSI report corresponding to a different NZP CSI-RS (or CMR) occasion. However, existing beam reporting mechanisms are not optimized for historical beam measurement reports. For example, techniques to report L1-RSRP and/or L1-SINR measurements typically convey an RSRP or SINR of a CRI and/or SSBRI associated with a strongest (e.g., largest) RSRP. As a result, each CSI report might include CRI/SSBRI values for different beams over time. However, to track beam quality, data showing how the quality of a beam changes in a time domain may be useful. In that sense, a common CRI/SSBRI of beam reporting over time domain may improve time domain beam prediction. For example, referring to FIG. 4, reference number 450 depicts an example of an enhanced CSI report that includes a common CRI/SSBRI for different CMRs and a separate L1 measurement for each respective CMR. In addition, a UCI payload size may be reduced if a common CRI/SSBRI for multiple CSI is supported. Accordingly, by improving L1 beam reporting mechanisms, the performance of temporal beam prediction may be improved.

Some aspects described herein relate to techniques to identify one or more CMRs to track across multiple measurement occasions in a time domain, such that the one or more CMRs that are tracked across the multiple measurement occasions may be addressed in one or more CSI reports that include L1 measurements for the one or more CMRs. For example, in some aspects, the one or more CSI reports may include an enhanced CSI report that includes a common CRI and/or SSBRI associated with the one or more CMRs and separate L1-RSRP and/or L1-SINR measurements associated with each respective CMR. Additionally, or alternatively, multiple CSI reports may be provided by the UE, where the multiple CSI reports each include an L1 measurement associated with one of the CMRs that are tracked over the multiple measurement occasions. Furthermore, some aspects described herein relate to criteria that may be used to identify the CMRs that are tracked over the multiple measurement occasions. For example, in some aspects, the CMRs may correspond to one or more candidate CMRs that have strongest L1 measurements in a first occasion, of the multiple measurement occasions in the time domain, one or more candidate CMRs that have strongest L1 measurements in a last occasion, of the multiple measurement occasions in the time domain, one or more candidate CMRs that have strongest L1 measurements, averaged over the multiple measurement occasions in the time domain, and/or one or more candidate CMRs that were reported and/or had strong L1 measurements in one or more previous measurement occasions and/or CSI reporting instances.

Additionally, or alternatively, the UE may autonomously select one or more criteria that are used to identify the CMRs to be addressed in one or more CSI reports that span multiple measurement occasions. Furthermore, some aspects described herein relate to techniques that a network node may use to configure or indicate the criteria to be used to select the CMRs to be addressed in the one or more CSI reports and/or techniques that a UE may use to indicate the criteria that were used to select the CMRs addressed in the one or more CSI reports. In this way, some aspects described herein may be used to identify the CMRs that a UE tracks over time, which may improve L1 beam reporting mechanisms that track multiple historical time domain occasions associated with identical CMRs and thereby improve the performance of temporal beam prediction.

As indicated above, FIG. 4 is provided as an example. Other examples may differ from what is described with regard to FIG. 4.

FIGS. 5A-5B are diagrams illustrating examples 500 associated with criteria to identify CMRs for a multiple time domain occasions L1 report, in accordance with the present disclosure. As shown in FIGS. 5A-5B, examples 500 include communication between a network node 110 and a UE 120. In some aspects, the network node 110 and the UE 120 may be included in a wireless network, such as wireless network 100. The network node 110 and the UE 120 may communicate via a wireless access link, which may include an uplink and a downlink. In some aspects, as described herein, some aspects relate to techniques that may enable the UE 120 to identify one or more CMRs to be addressed in a single L1 report (or CSI report) that includes L1 measurements spanning multiple historical measurement occasions. For example, as described in further detail herein, some aspects relate to techniques to configure, indicate, signal, or otherwise determine one or more criteria that the UE 120 may apply to select one or more CMRs to be tracked across multiple historical measurement occasions.

As shown in FIG. 5A, and by reference number 510, the network node 110 may transmit, and the UE 120 may receive, signaling that configures, activates, and/or triggers a CSI report associated with multiple time domain measurement occasions. For example, in some aspects, the network node 110 may transmit information to configure one or more CSI report settings associated with the CSI report associated with multiple time domain measurement occasions. The CSI report may include an enhanced CSI report that includes one or more common L1 measurements for various CMRs and individual L1 measurements for each individual CMR, or multiple CSI reports that include individual L1 measurements for each individual CMR. In some aspects, the CSI report configured, activated, or triggered by the network node 110 may be an aperiodic CSI report that is configured by RRC signaling (e.g., using a CSI-AssociatedReportConfigInfo parameter), a semi-persistent CSI report that is activated by a MAC-CE, an aperiodic CSI report that is triggered by DCI, or the like. In general, the signaling provided by the network node 110 may configure the UE 120 to provide CSI feedback via one or more CSI reports that include L1 measurements (e.g., L1-RSRP and/or L1-SINR measurements) associated with a set of one or more CMRs (e.g., corresponding to one or more SSBs and/or CSI-RSs), which are captured over multiple historical measurement occasions. For example, as shown in FIG. 5A, reference number 520 depicts a set of time domain measurement occasions associated with a CSI report, where the set of time domain measurement occasions includes multiple historical measurement occasions that are each associated with a set of candidate CMRs.

Accordingly, as shown by reference number 530, the UE 120 may measure the CMRs associated with the various time domain measurement occasions associated with a current CSI reporting instance. For example, each CSI reporting instance may be associated with multiple measurement occasions, and each measurement occasion may be associated with multiple candidate CMRs (e.g., SSBs or CSI-RSs). Accordingly, in each measurement occasion associated with the current CSI report instance, the UE 120 may measure each candidate CMR. As further shown by reference number 540, the UE may select, from the set of candidate CMRs, one or more CMRs to be addressed in the CSI report based on one or more candidate selection criteria. For example, in a CSI report associated with multiple historical measurement occasions in a time domain, the L1 measurements that are reported across the various historical measurement occasions may be associated with the same set of CMRs, which may be referred to herein as time domain-occasion common CMRs or using other suitable terminology. Alternatively, in some aspects, the L1 measurements that are reported across the various historical measurement occasions may be captured in multiple CSI reports (e.g., via the same or separate physical uplink shared channel (PUSCH) transmissions) that each capture one time domain measurement occasion. Nonetheless, even in such cases, the CMR(s) addressed in the multiple CSI reports may be identical across the various CSI reports.

In some aspects, when selecting the one or more CMRs to be addressed in the CSI report(s), the UE 120 may select the one or more CMRs from a set of candidate CMRs based on one or more candidate selection criteria. For example, in some aspects, the one or more candidate selection criteria may be defined in one or more wireless communication standards, configured or indicated by the network node 110, and/or based on one or more candidate selection criteria that are autonomously selected by the UE 120 and reported to the network node 110. For example, in some aspects, reference number 552 depicts a candidate selection criterion in which the one or more CMRs to be addressed in the CSI report(s) are determined or otherwise selected based on the CMRs that are associated with strongest L1 measurements (e.g., strongest L1-RSRP and/or L1-SINR measurements) in a first occasion, of multiple time domain measurement occasions associated with the CSI report. For example, reference number 552 depicts a set of CMRs associated with a gray fill pattern to indicate one or more CMRs that are associated with strongest L1 measurements in a first occasion, of multiple time domain measurement occasions associated with the CSI report.

Additionally, or alternatively, reference number 554 depicts a candidate selection criterion in which the one or more CMRs to be addressed in the CSI report(s) are determined or otherwise selected based on the CMRs that are associated with strongest L1 measurements in a last occasion, of the multiple time domain measurement occasions associated with the CSI report. For example, reference number 554 depicts a set of CMRs associated with a gray fill pattern to indicate one or more CMRs that are associated with strongest L1 measurements in a last occasion, of multiple time domain measurement occasions associated with the CSI report. Additionally, or alternatively, reference number 556 depicts a candidate selection criterion in which the one or more CMRs to be addressed in the CSI report(s) are determined or otherwise selected based on the CMRs that have strongest L1 measurements, when averaged over all of the multiple time domain measurement occasions associated with the CSI report.

Additionally, or alternatively, as shown by reference number 558, the candidate selection criteria may be based at least in part on one or more CMRs that were reported in one or more previous CSI reporting instances and/or measurement results that were obtained in one or more previous CSI reporting instances. For example, when determining the one or more CMRs to be addressed in a current CSI reporting instance based on one or more CMRs that were reported in one or more previous CSI reporting instances, the UE 120 may identify a set of L1-RSRP and/or L1-SINR measurements with respect to a strongest {S₁, S₂, . . . , S_{L}} CMRs that were reported for the {last, 2^{nd} last, . . . , Lth last} measurement occasions during the {last, 2^{nd} last, . . . , L'th last} previous reporting instances and include the CMRs associated with the identified set of L1-RSRP and/or L1-SINR measurements in the current CSI reporting occasion (e.g., one or more CMRs associated with and/or reported with the strongest reported L1-RSRP(s) and/or L1-SINR(s) from a last time domain occasion of a most recent CSI reporting instance may be retained in a current CSI reporting instance). In such cases, the values of {S₁, S₂, . . . , S_{L}} and/or {L, L′} may be defined in one or more wireless communication standards, may be configured or indicated by the network node 110, and/or may be based on reporting by the UE 120 based on any suitable signaling framework described in more detail elsewhere herein. Additionally, or alternatively, when determining the one or more CMRs to be addressed in a current CSI reporting instance based on one or more CMRs that were reported in one or more previous CSI reporting instances, the UE 120 may identify a set of L1-RSRP and/or L1-SINR measurements with respect to a strongest {S₁, S₂, . . . , S_{L}} CMRs measured from the {last, 2^{nd} last, . . . , Lth last} measurement occasions during the {last, 2^{nd} last, . . . , L'th last} previous CSI reporting instances. In such cases, the CMRs associated with the set of L1-RSRP and/or L1-SINR measurements in the previous CSI reporting occasion(s) with the strongest measurements may be included in the CSI report for the current CSI reporing instance. Furthermore, in a similar manner as described above, the values of {S₁, S₂, . . . , S_{L}} and/or {L, L′} may be defined in one or more wireless communication standards, may be configured or indicated by the network node 110, and/or may be based on reporting by the UE 120 based on any suitable signaling framework described in more detail elsewhere herein.

Additionally, or alternatively, as described herein, the candidate selection criteria that are used to determine the CMRs to be addressed in the CSI report may be based at least in part on one or more candidate selection criteria that are autonomously or arbitrarily determined by the UE 120, where such candidate selection criteria may be transparent (e.g., unknown) to the network node 110.

In some aspects, the candidate selection criteria that the UE 120 uses to determine the one or more CMRs to be addressed in the CSI report may be configured and/or indicated by the network node 110. For example, in some aspects, the candidate selection criteria may be configured via RRC signaling that indicates one or more CSI report settings associated with the CSI report, or the candidate selection criteria may be RRC-configured by a CSI-AssociatedReportConfigInfo parameter associated with an aperiodic CSI report. Additionally, or alternatively, the candidate selection criteria may be indicated by a MAC-CE that activates a semi-persistent CSI report and/or may be dynamically indicated by one or more dedicated fields in a DCI message that triggers an aperiodic CSI report. Additionally, or alternatively, as described herein, the one or more candidate selection criteria may be autonomously determined by the UE 120.

In some aspects, when the network node 110 configures or indicates the candidate selection criteria that the UE 120 applies to select the CMRs to be addressed in the CSI report, the network node 110 may configure or indicate multiple candidate selection criteria that are each associated with a number of CMRs that are to be selected using the corresponding candidate selection criterion. For example, the network node 110 may generally configure the UE 120 to transmit a CSI report that includes L1 measurements for N CMRs, and the network node 110 may provide the UE 120 with a configuration or indication to include {N₁, N₂, . . . , N_{K}} CMRs in the CSI report based on {C₁, C₂, . . . , C_{K}}, where Cᵢ is a candidate selection criterion and N₁+N₂+ . . . +N_{K}≤N. In other words, the number of CMRs that are selected using each candidate selection criterion is configured such that the total number of CMRs addressed in the CSI report does not exceed the total number of CMRs addressed in the CSI report. Additionally, or alternatively, in cases where N₁+N₂+ . . . +N_{K}>N, the UE 120 may identify the CMRs to be included in the CSI report according to priority orders associated with the various candidate selection criteria until N CMRs have been identified. In such cases, the priority orders associated with the various candidate selection criteria may be defined in a wireless communication standard or configured or indicated by the network node 110 using any suitable signaling techniques described in more detail elsewhere herein. Furthermore, in some aspects, the values of {N₁, N₂, . . . , N_{K}} may be defined in a wireless communication standard and/or configured or indicated by the network node 110 using any suitable signaling techniques described herein.

In some aspects, in cases where the UE 120 is configured to transmit a CSI report that includes L1 measurements for N CMRs, and the number of CMRs that are selected after evaluating all of the candidate selection criteria configured or indicated by the network node 110 is less than N, the UE 120 may fill out the remaining CMRs via one or more autonomously determined criteria that are transparent to the network node 110. For example, in a scenario where the UE 120 is configured to include L1 measurements for six CMRs in the CSI report and the number of CMRs included in the CSI report is less than six, the UE 120 may select one or more additional CMRs to address in the CSI report using any suitable criterion or criteria until the total number of CMRs addressed in the CSI report is six. For example, the network node 110 may configure the UE 120 to transmit a CSI report that addresses six CMRs, including three CMRs associated with a first candidate selection criterion and three CMRs associated with a second candidate selection criterion, and the UE 120 may determine that there is one CMR that satisfies both the first candidate selection criterion and the second candidate selection criterion. In such an example, the UE 120 may select the sixth CMR based on one or more candidate selection criteria, which may be transparent to the network node 110. Additionally, or alternatively, the network node 110 may configure the transparent candidate selection technique as an additional criterion with a lowest priority order or a priority order that is defined in a wireless communication standard or configured or indicated by the network node 110.

In some aspects, as shown by reference number 560, the UE 120 may transmit, and the network node 110 may receive, a CSI report that includes historical L1 measurements for one or more CMRs that are selected based on the candidate selection criteria described herein. For example, in some aspects, the CSI report may include an enhanced CSI report that includes a common CRI/SSBRI for the various CMRs addressed in the enhanced CSI report and individual L1 measurements for each CMR addressed in the enhanced CSI report. Additionally, or alternatively, the CSI report may include multiple CSI reports associated with overlapping uplink transmission occasions, where each CSI report may include an L1 measurement associated with a corresponding CMR. Furthermore, in some aspects, the UE 120 may transmit, and the network node 110 may receive, one or more uplink messages (e.g., RRC, MAC-CE, and/or UCI messages) to report the candidate selection criteria that the UE 120 applied to select the CMRs addressed in a payload associated with the CSI report. For example, in some aspects, the network node 110 may configure or indicate multiple candidate selection criteria using any suitable signaling scheme described herein, and the UE 120 may report one or more of the candidate selection criteria that were chosen and used to identify the CMRs to be included in the payload associated with the CSI report. In some aspects, the candidate selection criteria applied by the UE 120 may be based on configured and/or indicated values {N₁, N₂, . . . , N_{K}} for the candidate selection criteria, and the UE 120 may report the option that the UE 120 chose.

Additionally, or alternatively, the candidate selection criteria may be defined in a wireless communication standard. In one example, as shown by reference number 570 in FIG. 5B, the UE 120 may use one or more RRC and/or MAC-CE messages (e.g., that are transmitted between CSI reporting instances) to report the candidate selection criteria that the UE 120 applied for one or more past and/or upcoming CSI reporting periods. Additionally, or alternatively, as shown by reference number 575, the UE 120 may report the candidate selection criteria that were used to select the CMRs addressed in the CSI report within the CSI report that is transmitted in a CSI reporting occasion. For example, the UE 120 may report a candidate selection criterion that the UE 120 applied to identify a certain CMR to be included in a certain CSI reporting occasion, for each of the CMRs addressed in the CSI report for the same CSI reporting occasion. For example, reference number 575 depicts an example where 8 CMRs are addressed in a single CSI report, including 3 CMRs associated with criterion m and 5 CMRs associated with criterion n, in which case the CSI report may include 8 bits to indicate the candidate selection criterion that was considered for each CMR.

In some aspects, as described herein, the UE 120 may be further configured to manage an occupation of one or more processing units based on a time when the UE 120 needs to finish all L1 measurements before packing UCI associated with the CSI report. For example, the UE 120 may generally identify the CMRs to be addressed in the CSI report based on the L1 measurement results on a last measurement occasion out of multiple measurement occasions associated with a certain CSI reporting occasion. For example, in a scenario where the UE 120 is configured to apply a first candidate selection criterion based on the strongest CMRs in a last measurement occasion among a set of measurement occasions associated with a CSI report and a second candidate selection criterion based on the strongest average CMRs over all measurement occasions associated with the CSI report, the UE 120 may need to have one or more processing units occupied by L1 measurements until the last measurement occasion associated with the CSI reporting occasion. Accordingly, in such cases, the UE 120 may identify a number of processing units to be occupied and/or a duration of time that the processing units are to be occupied. For example, in FIG. 5B, reference number 580 depicts a first option, where the UE 120 identifies the number of processing units to be occupied and the duration of the processing units being occupied such that a reduced number of processing units are occupied before the last measurement occasion is finished. For example, in the example shown by reference number 580, the number of processing units occupied by the UE 120 for the associated CSI report, until the first or last symbol of the last measurement occasion, is smaller than the number of processing units occupied by the 120 UE after the last symbol of the last measurement occasion. In this way, before finishing the measurement for the last occasion in the time domain, the UE 120 does not need to start UCI packing or perform additional calculations, whereby the number of occupied processing units may be less than the number of occupied processing units occupied after finishing the measurement for the last occasion in the time domain.

Additionally, or alternatively, as shown by reference number 585, the processing units of the UE 120 may be occupied only during and shortly after (e.g., within a threshold time after) each measurement occasion prior to the last measurement occasion. In such cases, before the first symbol of the last measurement occasion, the processing units that are occupied by the UE 120 for the associated CSI report, are only accounted starting from the first symbol of each measurement occasion, until Z′₃ symbols after the last symbol of the same measurement occasion, where a value of Z′₃ can be defined in a wireless communication standard and/or based on capability information that the UE 120 reports to the network node 110. In this way, before finishing the measurement for the last occasion in the time domain, the UE 120 does not need to carry out UCI packing or additional calculations, whereby the processing units of the UE 120 are occupied only during and shortly after each measurement occasion.

As indicated above, FIGS. 5A-5B are provided as examples. Other examples may differ from what is described with regard to FIGS. 5A-5B.

FIG. 6 is a diagram illustrating an example process 600 performed, for example, by a UE, in accordance with the present disclosure. Example process 600 is an example where the UE (e.g., UE 120) performs operations associated with criteria to identify CMRs for a multiple time domain occasions L1 report.

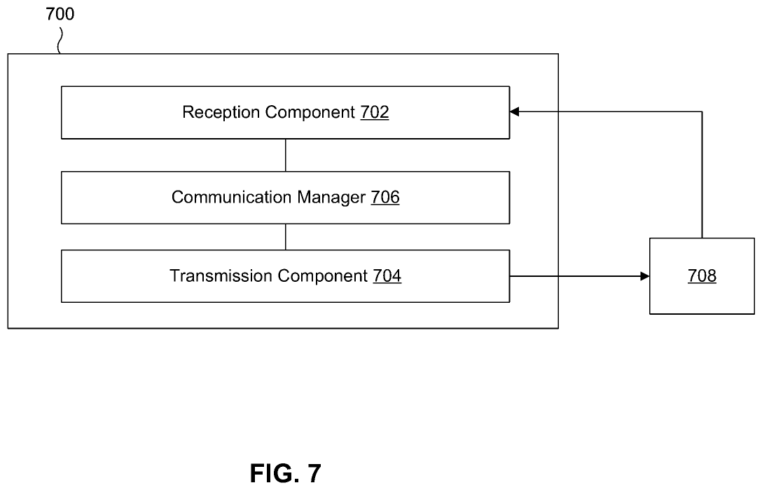

As shown in FIG. 6, in some aspects, process 600 may include receiving a CSI report configuration associated with reporting L1 measurements across multiple occasions in a time domain (block 610). For example, the UE (e.g., using reception component 702 and/or communication manager 706, depicted in FIG. 7) may receive a CSI report configuration associated with reporting L1 measurements across multiple occasions in a time domain, as described above, for example, with respect to reference number 510 in FIG. 5A.

As further shown in FIG. 6, in some aspects, process 600 may include selecting, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained (block 620). For example, the UE (e.g., using communication manager 706, depicted in FIG. 7) may select, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained, as described above, for example, with respect to reference number 540 and 552-558 in FIG. 5A.

As further shown in FIG. 6, in some aspects, process 600 may include transmitting a CSI report that includes the L1 measurements associated with the one or more CMRs across the multiple occasions in the time domain (block 630). For example, the UE (e.g., using transmission component 704 and/or communication manager 706, depicted in FIG. 7) may transmit a CSI report that includes the L1 measurements associated with the one or more CMRs across the multiple occasions in the time domain, as described above, for example, with respect to reference number 560 in FIG. 5A.

Process 600 may include additional aspects, such as any single aspect or any combination of aspects described below and/or in connection with one or more other processes described elsewhere herein.

In a first aspect, the one or more candidate selection criteria include one or more criteria to select one or more CMRs that have strongest L1 measurements in an initial occasion, of the multiple occasions in the time domain (e.g., as described above with respect to reference number 552 in FIG. 5A).

In a second aspect, alone or in combination with the first aspect, the one or more candidate selection criteria include one or more criteria to select one or more CMRs that have strongest L1 measurements in a last occasion, of the multiple occasions in the time domain (e.g., as described above with respect to reference number 554 in FIG. 5A).

In a third aspect, alone or in combination with one or more of the first and second aspects, the one or more candidate selection criteria include one or more criteria to select one or more CMRs that have strongest L1 measurements, averaged across the multiple occasions in the time domain (e.g., as described above with respect to reference number 556 in FIG. 5A).

In a fourth aspect, alone or in combination with one or more of the first through third aspects, the one or more candidate selection criteria include one or more criteria to select one or more CMRs associated with one or more previous CSI report instances or L1 measurements in one or more time domain occasions associated with one or more previous CSI report instances (e.g., as described above with respect to reference number 558 in FIG. 5A).

In a fifth aspect, alone or in combination with one or more of the first through fourth aspects, the one or more CMRs selected based on the one or more candidate selection criteria include one or more CMRs associated with strongest L1 measurements reported in the one or more previous CSI report instances (e.g., as described above with respect to reference number 540 in FIG. 5A).

In a sixth aspect, alone or in combination with one or more of the first through fifth aspects, the one or more CMRs selected based on the one or more candidate selection criteria include one or more CMRs associated with strongest L1 measurements obtained in measurement occasions associated with the one or more previous CSI report instances (e.g., as described above with respect to reference number 540 in FIG. 5A).

In a seventh aspect, alone or in combination with one or more of the first through sixth aspects, the one or more candidate selection criteria include one or more criteria that are autonomously determined by the UE (e.g., as described above with respect to reference number 540 in FIG. 5A).

In an eighth aspect, alone or in combination with one or more of the first through seventh aspects, process 600 includes receiving, from a network node, signaling that configures the one or more candidate selection criteria (e.g., as described above with respect to reference number 510 and 540 in FIG. 5A).

In a ninth aspect, alone or in combination with one or more of the first through eighth aspects, the one or more candidate selection criteria configured by the network node include multiple candidate selection criteria that are each associated with a respective number of CMRs to address in the CSI report (e.g., as described above with respect to reference number 510 and 540 in FIG. 5A).

In a tenth aspect, alone or in combination with one or more of the first through ninth aspects, the multiple candidate selection criteria are associated with a total number of CMRs that does not exceed a total number of CMRs to address in the CSI report (e.g., as described above with respect to reference number 510 and 540 in FIG. 5A).

In an eleventh aspect, alone or in combination with one or more of the first through tenth aspects, the multiple candidate selection criteria are associated with a total number of CMRs that exceeds a total number of CMRs to address in the CSI report, and the one or more CMRs are selected according to a priority order associated with the multiple candidate selection criteria until a number of the selected CMRs equals the total number of CMRs to address in the CSI report (e.g., as described above with respect to reference number 510 and 540 in FIG. 5A).

In a twelfth aspect, alone or in combination with one or more of the first through eleventh aspects, selecting the one or more CMRs includes selecting a first number of CMRs to address in the CSI report according to the one or more candidate selection criteria configured by the network node, and selecting a second number of CMRs to address in the CSI report based on one or more criteria that are autonomously determined by the UE based on the first number of CMRs being less than a total number of CMRs to address in the CSI report (e.g., as described above with respect to reference number 540 in FIG. 5A).

In a thirteenth aspect, alone or in combination with one or more of the first through twelfth aspects, process 600 includes transmitting information that indicates the one or more candidate selection criteria used to select the one or more CMRs associated with the L1 measurements included in the CSI report (e.g., as described above with respect to reference number 570 and 575 in FIG. 5B).

In a fourteenth aspect, alone or in combination with one or more of the first through thirteenth aspects, the information that indicates the one or more candidate selection criteria is transmitted in an uplink message that is separate from the CSI report to indicate the one or more candidate selection criteria used in one or more past CSI reporting instances or one or more upcoming CSI reporting instances (e.g., as described above with respect to reference number 570 in FIG. 5B).

In a fifteenth aspect, alone or in combination with one or more of the first through fourteenth aspects, the information that indicates the one or more candidate selection criteria is transmitted in the CSI report (e.g., as described above with respect to reference number 575 in FIG. 5B).

In a sixteenth aspect, alone or in combination with one or more of the first through fifteenth aspects, a number of processing units that are occupied by the L1 measurements prior to a last occasion, of the multiple occasions in the time domain that are associated with the CSI report, is less than a number of processing units that ae occupied after the last occasion, of the multiple occasions in the time domain that are associated with the CSI report (e.g., as described above with respect to reference number 580 in FIG. 5B).

In a seventeenth aspect, alone or in combination with one or more of the first through sixteenth aspects, one or more processing units are occupied by the L1 measurements only during a time period that starts from a first symbol and ends a threshold number of symbols after a last symbol of each occasion, of the multiple occasions in the time domain that are associated with the CSI report (e.g., as described above with respect to reference number 585 in FIG. 5B).

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 140 described in connection with FIG. 1. As shown, the apparatus 700 may communicate with another apparatus 708, such as a UE or a network node (such as a CU, a DU, an RU, or a base station), using the reception component 702 and the transmission component 704.

In some aspects, the apparatus 700 may be configured to perform one or more operations described herein in connection with FIGS. 5A-5B. Additionally, or alternatively, the apparatus 700 may be configured to perform one or more processes described herein, such as process 600 of FIG. 6. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 708. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive a CSI report configuration associated with reporting L1 measurements across multiple occasions in a time domain. The communication manager 706 may select, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained. The transmission component 704 may transmit a CSI report that includes the L1 measurements associated with the one or more CMRs across the multiple occasions in the time domain.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a UE, comprising: receiving a CSI report configuration associated with reporting L1measurements across multiple occasions in a time domain; selecting, among a set of candidate CMRs that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1measurements are obtained; and transmitting a CSI report that includes the L1measurements associated with the one or more CMRs across the multiple occasions in the time domain.
Aspect 2: The method of Aspect 1, wherein the one or more candidate selection criteria include one or more criteria to select one or more CMRs that have strongest L1 measurements in an initial occasion, of the multiple occasions in the time domain.
Aspect 3: The method of any of Aspects 1-2, wherein the one or more candidate selection criteria include one or more criteria to select one or more CMRs that have strongest L1 measurements in a last occasion, of the multiple occasions in the time domain.
Aspect 4: The method of any of Aspects 1-3, wherein the one or more candidate selection criteria include one or more criteria to select one or more CMRs that have strongest L1 measurements, averaged across the multiple occasions in the time domain.
Aspect 5: The method of any of Aspects 1-4, wherein the one or more candidate selection criteria include one or more criteria to select one or more CMRs associated with one or more previous CSI report instances or L1 measurements in one or more time domain occasions associated with one or more previous CSI report instances.
Aspect 6: The method of Aspect 5, wherein the one or more CMRs selected based on the one or more candidate selection criteria include one or more CMRs associated with strongest L1 measurements reported in the one or more previous CSI report instances.
Aspect 7: The method of any of Aspects 5-6, wherein the one or more CMRs selected based on the one or more candidate selection criteria include one or more CMRs associated with strongest L1 measurements obtained in measurement occasions associated with the one or more previous CSI report instances.
Aspect 8: The method of any of Aspects 1-7, wherein the one or more candidate selection criteria include one or more criteria that are autonomously determined by the UE.
Aspect 9: The method of any of Aspects 1-8, further comprising: receiving, from a network node, signaling that configures the one or more candidate selection criteria.
Aspect 10: The method of Aspect 9, wherein the one or more candidate selection criteria configured by the network node include multiple candidate selection criteria that are each associated with a respective number of CMRs to address in the CSI report.
Aspect 11: The method of Aspect 10, wherein the multiple candidate selection criteria are associated with a total number of CMRs that does not exceed a total number of CMRs to address in the CSI report.
Aspect 12: The method of Aspect 10, wherein the multiple candidate selection criteria are associated with a total number of CMRs that exceeds a total number of CMRs to address in the CSI report, and wherein the one or more CMRs are selected according to a priority order associated with the multiple candidate selection criteria until a number of the selected CMRs equals the total number of CMRs to address in the CSI report.
Aspect 13: The method of Aspect 9, wherein selecting the one or more CMRs includes: selecting a first number of CMRs to address in the CSI report according to the one or more candidate selection criteria configured by the network node; and selecting a second number of CMRs to address in the CSI report based on one or more criteria that are autonomously determined by the UE based on the first number of CMRs being less than a total number of CMRs to address in the CSI report.
Aspect 14: The method of any of Aspects 1-13, further comprising: transmitting information that indicates the one or more candidate selection criteria used to select the one or more CMRs associated with the L1 measurements included in the CSI report.

Aspect 15: The method of Aspect 14, wherein the information that indicates the one or more candidate selection criteria is transmitted in an uplink message that is separate from the CSI report to indicate the one or more candidate selection criteria used in one or more past CSI reporting instances or one or more upcoming CSI reporting instances.

Aspect 16: The method of Aspect 14, wherein the information that indicates the one or more candidate selection criteria is transmitted in the CSI report.

Aspect 17: The method of any of Aspects 1-16, wherein a number of processing units that are occupied by the L1 measurements prior to a last occasion, of the multiple occasions in the time domain that are associated with the CSI report, is less than a number of processing units that ae occupied after the last occasion, of the multiple occasions in the time domain that are associated with the CSI report.

Aspect 18: The method of any of Aspects 1-17, wherein one or more processing units are occupied by the L1 measurements only during a time period that starts from a first symbol and ends a threshold number of symbols after a last symbol of each occasion, of the multiple occasions in the time domain that are associated with the CSI report.

Aspect 19: An apparatus for wireless communication at a device, comprising a processor; memory coupled with the processor; and instructions stored in the memory and executable by the processor to cause the apparatus to perform the method of one or more of Aspects 1-18.

Aspect 20: A device for wireless communication, comprising a memory and one or more processors coupled to the memory, the one or more processors configured to perform the method of one or more of Aspects 1-18.

Aspect 21: An apparatus for wireless communication, comprising at least one means for performing the method of one or more of Aspects 1-18.

Aspect 22: A non-transitory computer-readable medium storing code for wireless communication, the code comprising instructions executable by a processor to perform the method of one or more of Aspects 1-18.

Aspect 23: A non-transitory computer-readable medium storing a set of instructions for wireless communication, the set of instructions comprising one or more instructions that, when executed by one or more processors of a device, cause the device to perform the method of one or more of Aspects 1-18.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communications, comprising:
one or more memories; and
one or more processors, coupled to the one or more memories, configured to:
receive a channel state information (CSI) report configuration associated with reporting Layer 1 (L1) measurements across multiple occasions in a time domain;
select, among a set of candidate channel measurement resources (CMRs) that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained; and
transmit a CSI report that includes the L1 measurements associated with the one or more CMRs across the multiple occasions in the time domain.

2. The UE of claim 1, wherein the one or more candidate selection criteria include one or more criteria to select one or more CMRs that have strongest L1 measurements in an initial occasion, of the multiple occasions in the time domain.

3. The UE of claim 1, wherein the one or more candidate selection criteria include one or more criteria to select one or more CMRs that have strongest L1 measurements in a last occasion, of the multiple occasions in the time domain.

4. The UE of claim 1, wherein the one or more candidate selection criteria include one or more criteria to select one or more CMRs that have strongest L1 measurements, averaged across the multiple occasions in the time domain.

5. The UE of claim 1, wherein the one or more candidate selection criteria include one or more criteria to select one or more CMRs associated with one or more previous CSI report instances or L1 measurements in one or more time domain occasions associated with one or more previous CSI report instances.

6. The UE of claim 5, wherein the one or more CMRs selected based on the one or more candidate selection criteria include one or more CMRs associated with strongest L1 measurements reported in the one or more previous CSI report instances.

7. The UE of claim 5, wherein the one or more CMRs selected based on the one or more candidate selection criteria include one or more CMRs associated with strongest L1 measurements obtained in measurement occasions associated with the one or more previous CSI report instances.

8. The UE of claim 1, wherein the one or more candidate selection criteria include one or more criteria that are autonomously determined by the UE.

9. The UE of claim 1, wherein the one or more processors are further configured to:
receive, from a network node, signaling that configures the one or more candidate selection criteria.

10.-18 (canceled)

19. A method for wireless communications, comprising:
receiving a channel state information (CSI) report configuration associated with reporting Layer 1 (L1) measurements across multiple occasions in a time domain;
selecting among a set of candidate channel measurement resources (CMRs) that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained; and
transmitting a CSI report that includes the L1 measurements associated with the one or more CMRs across the multiple occasions in the time domain.

20. The method of claim 19, wherein the one or more candidate selection criteria include one or more criteria to select one or more CMRs that have strongest L1 measurements in an initial occasion, of the multiple occasions in the time domain.

21. The method of claim 19, wherein the one or more candidate selection criteria include one or more criteria to select one or more CMRs that have strongest L1 measurements in a last occasion, of the multiple occasions in the time domain.

22. The method of claim 19, wherein the one or more candidate selection criteria include one or more criteria to select one or more CMRs that have strongest L1 measurements, averaged across the multiple occasions in the time domain.

23. The method of claim 19, wherein the one or more candidate selection criteria include one or more criteria to select one or more CMRs associated with one or more previous CSI report instances or L1 measurements in one or more time domain occasions associated with one or more previous CSI report instances.

24. The method of claim 19, wherein the one or more candidate selection criteria include one or more criteria that are autonomously determined by the UE.

25. The method of claim 19, further comprising:
receiving from a network node, signaling that configures the one or more candidate selection criteria.

26. The method of claim 19, further comprising:
transmitting information that indicates the one or more candidate selection criteria used to select the one or more CMRs associated with the L1 measurements included in the CSI report.

27. The method of claim 19, wherein a number of processing units that are occupied by the L1 measurements prior to a last occasion, of the multiple occasions in the time domain that are associated with the CSI report, is less than a number of processing units that ae occupied after the last occasion, of the multiple occasions in the time domain that are associated with the CSI report.

28. The method of claim 19, wherein one or more processing units are occupied by the L1 measurements only during a time period that starts from a first symbol and ends a threshold number of symbols after a last symbol of each occasion, of the multiple occasions in the time domain that are associated with the CSI report.

29. A non-transitory computer-readable medium storing a set of instructions for wireless communication, the set of instructions comprising:
one or more instructions that, when executed by one or more processors of a user equipment (UE), cause the UE to:
receive a channel state information (CSI) report configuration associated with reporting Layer 1 (L1) measurements across multiple occasions in a time domain;
select, among a set of candidate channel measurement resources (CMRs) that are associated with L1 measurements across the multiple occasions in the time domain, one or more CMRs based on one or more candidate selection criteria, wherein the one or more candidate selection criteria are based on at least one of a relative strength of the L1 measurements or occasions in which the L1 measurements are obtained; and
transmit a CSI report that includes the L1 measurements associated with the one or more CMRs across the multiple occasions in the time domain.

30. (canceled)
